(19) United States
(12) Patent Application Publication
(10) Pub. No.: US 2026/0088005 A1
(43) Pub. Date: Mar. 26, 2026

(54) HARMONICA PAD

(71) Applicant: Stanislav Vladimirovich PANKRATOV, Yekaterinburg (RU)

(72) Inventor: Stanislav Vladimirovich PANKRATOV, Yekaterinburg (RU)

(21) Appl. No.: 19/403,459

(22) Filed: Nov. 28, 2025

Related U.S. Application Data
(63) Continuation of application No. PCT/RU2024/000248, filed on Jul. 29, 2024.

(30) Foreign Application Priority Data
May 30, 2023 (RU) 2023114131

(51) Int. Cl. G10D 7/14

(52) U.S. Cl. CPC G10D 7/14

(57) ABSTRACT

The invention relates to musical instruments, to their body pad or comb parts and can be used in the manufacture of harmonicas. Harmonica pad made in the form of a body part of a harmonica comprises air passage channels inside, each of which is formed by combined communicating internal volumes of horizontal inlet and vertical outlet through holes and said channels comprise one or two bypass holes made with the intersection of said horizontal inlets for each channel. When one or two bypass holes of the corresponding channel are completely closed, the maximum flow rate and pressure of the air passing through the vertical through outlet for the reeds of the plates is achieved. Accordingly, when one or two bypass holes of the corresponding channel are fully opened, the minimum flow rate and pressure of air passing through the vertical through outlet for the reeds of the plates is achieved.

### CROSS-REFERENCE TO RELATED APPLICATIONS

The application claims priority to Russian patent application No. 2023114131, filed on May 30, 2023, the entire contents of which are incorporated herein by reference.

### TECHNICAL FIELD

The invention relates to musical instruments, in particular, to the general design of free-reed wind musical instruments, namely, to their body pad or comb parts and can be used in the manufacture of harmonicas.

### BACKGROUND

A harmonica is known from the prior art, comprising a pad with double-row channels for air passage, two bars with vocal reeds and a plate tone switch, wherein, in order to increase performance capabilities, it has an additional plate switch, which allows, in interaction with the main one, obtaining the desired combination of chords from a twenty-four-tone octave.

A harmonica is also known from the prior art (Patent WO2019186244 A1, 03.10.2019, G10D7/14, G10D9/00), comprising a body with several holes sequentially arranged on the same axis for air passage, each hole having a reed located inside the body and configured to form a note upon exhalation under the influence of the outgoing air, as well as a reed located inside the body and configured to form a note upon inhalation under the influence of incoming air, whereas the reeds are configured to form notes upon exhalation during the passage of air, which include repeating groups of the first, third and sixth notes of the major scale, as well as notes upon inhalation, which include repeating groups from the second, fifth and seventh notes of the major scale, whereas the notes upon exhalation and inhalation are arranged in the following repeating sequence: first-second, third-fifth, sixth-seventh notes.

The closest technical solution is an improved harmonica (Patent FR3106925 A1, Aug. 6, 2021, G10D7/14), comprising a comb made with multiple chambers, each of which comprises a hole designed to allow the user's air to pass through, and forms an oscillating space for the blow reed, as well as an oscillating space for the exhaust reed, whereas the blow reed and exhaust reed of each chamber form a pair of additional reeds.

### SUMMARY

The main disadvantage of the above-described technical solutions is the low accuracy of air pressure and flow control through the reeds of the plates for inhaling and exhaling air.

The technical effect of the claimed invention is:
1. expanding the operational capabilities, which consist in increasing the accuracy of regulating the pressure and air flow through the reeds of the plates for inhaling and exhaling air of the harmonica, as well as efficiently change and expand the range of control of the amplitude and tone color of the sound signal emitted by the harmonica upon inhaling and exhaling,
2. expanding the dynamic shades of sound, the range of sound of the harmonica, playing chords and intervals through the holes for inhaling and exhaling air through the reeds of the plates and reeds of the plates,
3. ability to extract intervals through the reeds of the plates arranged in a checkerboard pattern and adjust the volume of the note bend on the harmonica,
4. ability to accentuate a particular note in a chord or interval

The specified technical effect is achieved because the harmonica pad is made as a body part of a harmonica and comprises air channels inside, each of which is formed by combined communicating internal volumes of horizontal inlet holes and vertical through outlet holes characterized in that said channels further comprise one or two bypass holes made with the intersection of said horizontal inlet holes for each said channel.

Moreover, said channels additionally comprise one or two bypass holes made on one of said flat surfaces of the device or on its two said flat surfaces, respectively, and with the intersection of said horizontal inlet holes for each said channel.

When one or two bypass holes of the corresponding channel are completely closed, the maximum flow rate and pressure of the air passing through the vertical through outlet for the reeds of the plates is achieved. Accordingly, when one or two bypass holes of the corresponding channel are fully opened, the minimum flow rate and pressure of air passing through the vertical through outlet for the reeds of the plates is achieved.

In particular, said flat shape of the monolithic body part of the harmonica can have a rectangular contour with rounded corners, and the device may comprise inside at least ten said channels parallel to each other, as well as to the short and flat end surfaces of the device, which are formed separately for each of them by combined communicating internal volumes of said horizontal inlet holes with the same cross-section, made on one of the long end surfaces of the device, parallel to each other, and said vertical outlet through holes with rectangular cross-sections, made perpendicular to the flat surfaces of the device and parallel to the short parts of said rectangular cross-sections to said end long surfaces of the device with a stepwise reduction of said rectangular cross-sections along their long part from the second end long surfaces of the device—in a stepwise manner from one end short surface to the other.

Whereas said channels may additionally comprise one or two bypass holes parallel to each other with the same cross-section, made through vertical projections on one of said flat surfaces of the device or on its two said flat surfaces, respectively, and located perpendicular to said horizontal inlet holes with their intersection separately for each said channel.

In addition, on the flat surfaces of the device, parallel and symmetrically relative to the axis passing through the mid-thickness of one of said end short surfaces of the device and perpendicular to said end long surfaces of the device, two rectangular grooves or recesses with rounded corners can be made, in which side ribs or projections are located in a similar manner, parallel and symmetrically relative to said axis, which are arranged in pairs and longitudinally to said short end surfaces of the device along the edges of said grooves or recesses, with mounting holes for fixing the upper and lower covers of the harmonica, as well as contoured ribs or protrusions made both along the combined contour of said vertical outlet through holes, and between them, with compensating ribs or protrusions located between said second long end surface of the device and said vertical outlet through holes with said stepwise-reduced cross-section and forming with said contour ribs or protrusions a combined rib contour for fastening and rigid securing without pushing through the upper and lower plate with reeds (not shown in the figures) by means of mounting holes.

Moreover, said sections of said horizontal inlet holes, bypass holes and their vertical projections can be made of rectangular shapes, the short parts of which are parallel to said long end surfaces of the device.

In this case, the device can be made of wood, or metal, or an alloy of metals, or composite or polymer materials.

### BRIEF DESCRIPTION OF THE DRAWINGS

The essence of the invention is explained by drawings showing a special case of the claimed harmonica pads:

FIG. 1 shows a front view of the harmonica pads in the embodiment with two bypass holes for each channel;

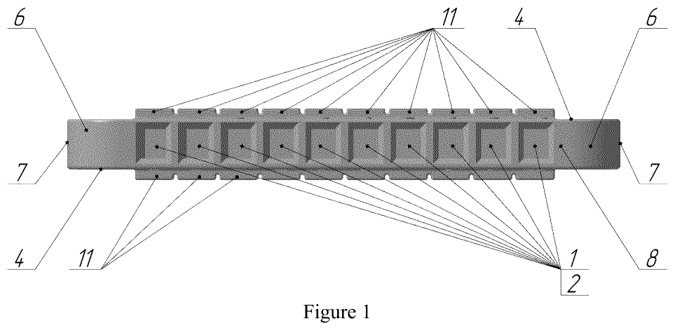

FIG. 2 shows an axonometry of the general view of the harmonica pads in the embodiment with two bypass holes for each channel;

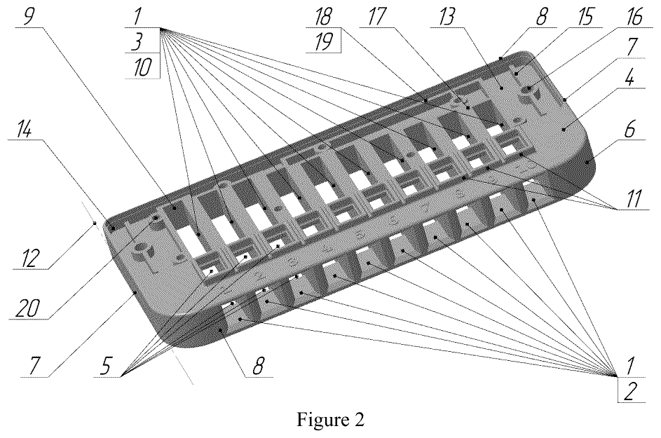

FIG. 3 shows a general axonometry with a quarter cutout of the harmonica pad in the embodiment with two bypass holes for each channel;

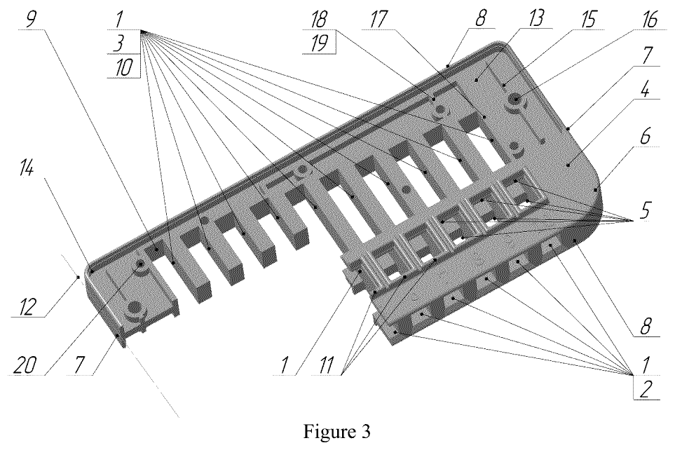

FIG. 4 shows a front view of the harmonica pad in the embodiment with one bypass hole for each channel;

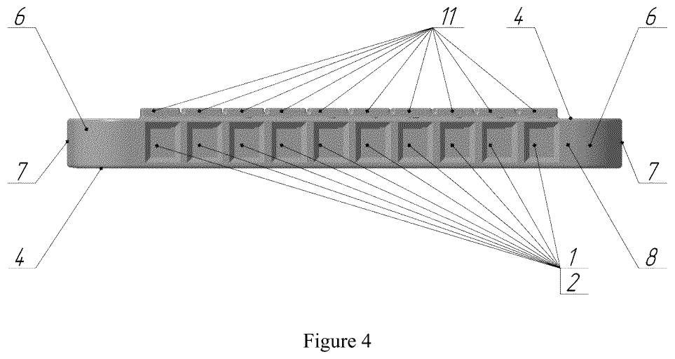

FIG. 5 shows an axonometry of the general view of the harmonica pad in the embodiment with one bypass hole for each channel;

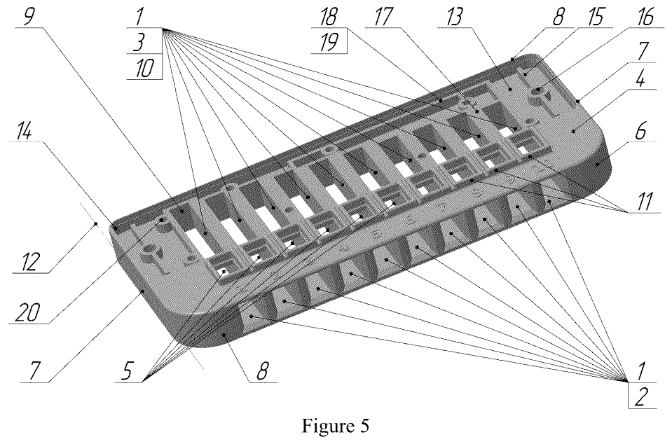

FIG. 6 shows an axonometry of the general view with a quarter cutout of the harmonica pad in the embodiment with one bypass hole for each channel;

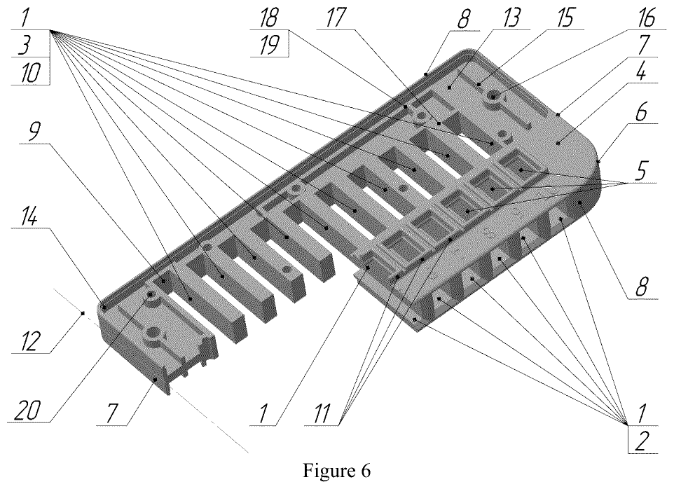

FIG. 7 shows an axonometry of the general view of the harmonica pad in the embodiment with a cavity for installing bypass valves for each channel, where:

1—channels for air passage;
2—horizontal inlet holes relative to the flat surfaces of the device (holes for charging or discharging air);
3—vertical outlet through holes relative to the flat surfaces of the device;
4—flat surfaces of the device;
5—bypass holes made on one of the flat surfaces of the device or on two of its flat surfaces, respectively;
6—rounded corners of the monolithic body of the harmonica;
7—short end surfaces of the device;
8—long end surfaces of the device;
9—short parts of rectangular sections of vertical outlet through holes;
10—long parts of rectangular sections of vertical outlet through holes;
11—vertical projections through which bypass holes can be made on one of the flat surfaces of the device or on two of its flat surfaces, respectively;
12—an axis along which two rectangular grooves or recesses are made in parallel and symmetrically on the flat surfaces of the device, in which side ribs or protrusions, contour ribs or protrusions, compensating ribs or protrusions and a combined rib contour for fastening and rigid securing without pushing through the upper and lower plates with reeds (not shown in the figures) are located in a similar manner in parallel or symmetrically relative to this axis;
13—two rectangular grooves or recesses;
14—fillets of two rectangular grooves or recesses;
15—side ribs or protrusions placed in pairs and longitudinally to the short end surfaces of the device along the edges of the grooves or recesses;
16—mounting holes of the side ribs or projections for securing the upper and lower covers of the harmonica (not shown in the figures);
17—contour ribs or protrusions;
18—compensating ribs or protrusions;
19—a combined rib contour for fastening and rigid securing without pushing through the upper and lower plates with reeds (not shown in the figures);
20—mounting holes of the combined rib contour;
21—a cavity for installing a common bypass valve or individual bypass valves;
22—holes for removing the common bypass valve or individual bypass valves;
23—vertical partitions between horizontal inlet holes;
24—a longitudinal groove for attaching the microphone holder.

### DETAILED DESCRIPTION OF THE EMBODIMENTS

A particular embodiment of the harmonica pad can be as follows: a harmonica pad made in the form of a monolithic body part of a flat-shaped harmonica comprises air channels 1 inside, each of which is formed by the combined communicating internal volumes of the horizontal inlet hole 2 (a hole for charging or discharging air) and a vertical outlet through hole 3 relative to the flat surfaces 4 of the device.

Whereas, said channels 1 additionally comprise one or two bypass holes 5 made on one of said flat surfaces 4 of the device or on its two said flat surfaces 4, respectively, and with the intersection of said horizontal inlet holes 2 for each of said channel 1.

Said flat shape of the monolithic body part of the harmonica can have a rectangular contour with rounded corners 6, and the device may comprise inside at least ten said channels 1 parallel to each other, as well as to the short end surfaces 7 and flat end surfaces 4 of the device, whereas said channels are formed separately for each of them by combined communicating internal volumes parallel to each other, as well as to the end short surfaces 7 and flat surfaces 4 of the device, whereas said horizontal inlet holes 2 with the same cross-section made on one of the end long surfaces 8 of the device and parallel to each other said vertical outlet through holes 3 with rectangular cross-sections made perpendicular to the flat surfaces 4 of the device and in parallel with the short parts 9 of said rectangular sections to said end long surfaces 8 of the device with a stepwise reduction of said rectangular sections along the long part 10 of them from the second one of end long surfaces 8 of the device—in a stepwise manner from one end short surface 7 to the other one.

In this case, said channels 1 may additionally comprise one or two bypass holes 5 parallel to each other with the same cross-section, made through vertical projections 11 on one of said flat surfaces 4 of the device or on its two said flat surfaces 4, respectively, and located perpendicular to said horizontal inlet holes 2 with their intersection separately for each said channel 1.

In addition, on the flat surfaces 4 of the device, parallel and symmetrically relative to the axis 12 passing through the mid-thickness of one of said end short surfaces 7 of the device and perpendicular to said end long surfaces 8 of the device, two rectangular grooves or recesses 13 with rounded corners 14 can be made, in which side ribs or projections 15 are located in a similar manner, parallel and symmetrically relative to said axis 12, which are arranged in pairs and longitudinally to said short end surfaces 7 of the device along the edges of said grooves or recesses 13, with mounting holes 16 for fixing the upper and lower covers of the harmonica (not shown in the figures), as well as contoured ribs or protrusions 17 made both along the combined contour of said vertical outlet through holes 3, and between them, with compensating ribs or protrusions 18 located between said second long end surface 8 of the device and said vertical outlet through holes 3 with said stepwise-reduced cross-section and forming, with said contour ribs or protrusions 17, a combined rib contour 19 for fastening and rigid securing without pushing through the upper and lower plate with reeds (not shown in the figures) by means of mounting holes 20.

Whereas said sections of said horizontal inlet holes 2, bypass holes 5 and their vertical projections 11 can be made of rectangular, oval or round shape.

In this case, the device can be made of wood, or metal, or an alloy of metals, or composite or polymer materials.

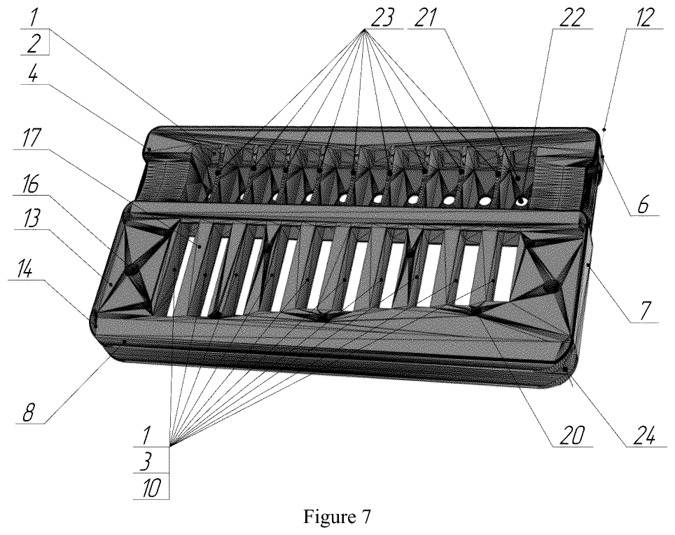

Another particular embodiment of the harmonica pad can be as follows (FIG. 7): a harmonica pad made in the form of a monolithic body part of a flat-shaped harmonica comprises air channels 1 inside, each of which is formed by the combined communicating internal volumes of the horizontal inlet hole 2 (a hole for charging or discharging air) and a vertical outlet through hole 3 relative to the flat surfaces 4 of the device.

Whereas on one of said flat surfaces 4 of the device, the channels 1 comprise a cavity 21 configured for installing a common bypass valve (not shown in the figures) for horizontal inlet holes 2, with the intersection of horizontal inlet holes 2 for each channel 1, and on the other one of said flat surfaces 4 of the device, the channels 1 comprise holes 22 to remove the bypass valve.

Whereas the cavity 21 between the horizontal inlet holes 2 can be separated by vertical partitions 23 configured to install bypass valves (not shown in the figures) separately for each of the horizontal inlet holes 2.

In addition, on the end long surface 8 of the device on the side of the vertical outlet through holes 3, a longitudinal groove 24 can be made along its length for attaching the microphone holder.

The harmonica pad and the harmonica with it are manufactured and assembled as follows: first, depending on the design of the device, flat surfaces 4 with vertical protrusions 11, short end surfaces 7 and long end surfaces 8 are made from flat rectangular pad blanks, for example, by laser or waterjet cutting, depending on the material of said blanks. Then, the fillets 6 are milled at the corners of the monolithic body part of the harmonica obtained from said blanks, as well as the longitudinal groove 24 for attaching the microphone holder to the end long surface 8 of the device on the side of the vertical outlet through holes 3. After that, similarly, by means of laser or waterjet cutting, two rectangular grooves or recesses 13 with fillets 14 and side ribs or protrusions 15, contour ribs or protrusions 17, compensating ribs or protrusions 18 and a combined rib contour 19 are cut out parallel and symmetrically along the axis 12. After that, channels 1 are drilled for air passage with bypass holes 5 or a cavity 21 with or without partitions 23 for installation of separate bypass valves or a common bypass valve (not shown in the figures). For this, the horizontal inlet holes 2 are first drilled or cut out. Then, vertical outlet through holes 3 are made in parallel with the short parts 9 of their rectangular sections to said end long surfaces 8 of the device with a stepwise reduction in their rectangular sections along the long part 10 of them from the second one of the end long surfaces 8 of the device—in a stepwise manner from one end short surface 7 to the other. And then, said bypass holes 5 with the same cross-section are drilled through vertical protrusions 11 on one of said flat surfaces 4 of the device or on its two said flat surfaces 4, respectively, perpendicular to said horizontal inlet holes 2 with their intersection separately for each said channel 1. After that, the mounting holes 16, 20 are drilled, and the resulting harmonica pad is grounded and treated (painted, baked, polished, etc.). Next, the harmonica is assembled. For this purpose, the upper and lower plates with reeds (not shown in the figures) are attached to the resulting pad through the mounting holes 20 of the combined rib contour 19 and rigidly secured without pressing through, and the upper and lower covers of the harmonica are secured through the mounting holes 16 (not shown in the figures).

A harmonica pad can be made using 3D printing and plastic casting.

A harmonica with a pad for it operates as follows: the harmonica is played by causing vibrations of the reeds mounted on the plates by inhaling or exhaling through the horizontal inlet holes 2 of the channels 1 for air passage. Whereas air is charged or discharged through said inlet holes 2 (when inhaling or exhaling), so that one part of the air volume enters through the vertical outlet holes 3 onto said plates with reeds, and the other part can exit through the bypass holes 5 or bypass valves (not shown in the figures), bypassing the vertical outlet holes 3. Whereas, the user can use his fingers to close said bypass 5 holes or bypass valves (not shown in the figures), and thereby regulate the process of bypassing the air flow in the channels 1, increasing or decreasing its flow rate or pressure as it passes through the vertical outlet through holes 3 onto said plates, bending the note that the reed is tuned to.

The specified technical effect is fully achieved because the design of air passage channels with bypass holes crossing horizontal inlet holes allows adding an adjustable amount of air to the flow that the musician creates, thereby regulating the flow rate and pressure of the air passing through each reed of the plates separately.

No technical solutions have been identified that coincide with the combination of the essential features of the claimed invention, which allows us to conclude that the claimed invention meets a patentability condition of novelty.

The claimed essential features that determine the specified technical effect do not explicitly follow from the prior art, which allows us to conclude that the claimed invention complies with a patentability condition of inventive level.

What is claimed is:

1. A harmonica pad made in the form of a body part of a harmonica and comprising air passage channels inside, each of which is formed by combined communicating internal volumes of horizontal inlet and vertical outlet through holes, characterized in that said channels additionally comprise one or two bypass holes made with the intersection of said horizontal inlets for each said channel.

2. The harmonica pad according to claim 1, characterized in that said flat shape of the monolithic body part of the harmonica has a rectangular contour with rounded corners, and also comprises inside at least ten said channels parallel to each other, as well as to the short and flat end surfaces of the device, which are formed separately for each of them by combined communicating internal volumes of said horizontal inlet holes with the same cross-section, made on one of the long end surfaces of the device, parallel to each other, and said vertical outlet through holes with rectangular cross-sections made perpendicular to the flat surfaces of the device and parallel to the short parts of said rectangular cross-sections to said end long surfaces of the device with a stepwise reduction of said rectangular cross-sections along their long part from the second end long surfaces of the device—in a stepwise manner from one end short surface to the other.

3. The harmonica pad according to claims 1-2, characterized in that said channels additionally comprise one or two bypass holes parallel to each other with the same cross-section, made through vertical projections on one of said flat surfaces of the device or on its two said flat surfaces, respectively, and located perpendicular to said horizontal inlet holes with their intersection separately for each said channel.

4. The harmonica pad according to claims 1-3, characterized in that on the flat surfaces of the device, parallel and symmetrically relative to the axis passing through the mid-thickness of one of said end short surfaces of the device and perpendicular to said end long surfaces of the device, two rectangular grooves or recesses with rounded corners are made, in which side ribs or projections are located in a similar manner parallel and symmetrically relative to said axis, which are arranged in pairs and longitudinally to said short end surfaces of the device along the edges of said grooves or recesses, with mounting holes for fixing the upper and lower covers of the harmonica, as well as contoured ribs or protrusions made both along the combined contour of said vertical outlet through holes, and between them, with compensating ribs or protrusions located between said second long end surface of the device and said vertical outlet through holes with said stepwise-reduced cross-section and forming with said contour ribs or protrusions a combined rib contour for fastening and rigid securing without pushing through the upper and lower plate with reeds (not shown in the figures) by means of mounting holes.

5. The harmonica pad according to claims 2-3, characterized in that said sections of said horizontal inlets, bypass holes and their vertical projections are made of rectangular, oval or round shape.

6. The harmonica pad according to claims 1-5, characterized in that it is made of wood, or metal, or an alloy of metals, or composite or polymer materials.
